(19) United States
(12) Patent Application Publication
(10) Pub. No.: US 2002/0098313 A1
(43) Pub. Date: Jul. 25, 2002

(54) Pressure-sensitive adhesive tape for preventing three-face adhesion of caulking material, joiner and working method for caulking

(75) Inventor: Hideki Nagatsu, Osaka (JP)

Correspondence Address: SUGHRUE MION ZINN, MACPEAK & SEAS, PLLC, 2100 Pennsylvania Avenue, NW, Washington, DC, 20037-3213, US

(73) Assignee: NITTO DENKO CORPORATION

(21) Appl. No.: 09/974,047

(22) Filed: Oct. 11, 2001

(30) Foreign Application Priority Data
Oct. 11, 2000 (JP) P. 2000-310873
Sep. 25, 2001 (JP) P. 2001-291344

(51) Int. Cl. B32B 7/12

(52) U.S. Cl. 428/61; 428/343

(57) ABSTRACT

A pressure-sensitive adhesive tape for preventing three-face adhesion of caulking materials comprising a tape-type substrate having provided on one face of the tape-type substrate a pressure-sensitive adhesive layer, wherein the above-described substrate comprises at least an exposed plastic sheet face and the above-described plastic sheet face has been surface-roughened, a joiner comprising this pressure-sensitive adhesive tape for preventing three-face adhesion of caulking materials, and a working method for caulking which comprises applying the pressure-sensitive adhesive tape for preventing three-face adhesion of caulking materials and filling a caulking material are described.

### FIELD OF THE INVENTION

This invention relates to pressure-sensitive adhesive tapes for preventing three-face adhesion of caulking materials, joiners and a working method for caulking. More particularly speaking, it relates to pressure-sensitive adhesive tapes for preventing three-face adhesion of caulking materials which are employed in caulking outer wall joints in constructions such as buildings and houses, joiners having these pressure-sensitive adhesive tapes and a working method for caulking with the use of these pressure-sensitive adhesive tapes.

### BACKGROUND OF THE INVENTION

To form outer walls of constructions such as buildings or houses by using ceramic or resin outer wallboards which are used as highly durable outer wall materials, it has been a practice to successively butt the side end faces of the boards and fix to wall substrates of the constructions. On the butted parts of these outer wallboards, joint grooves are formed and filling caulking materials in these joint grooves, i.e., so-called caulking, is performed to ensure sufficient water resistance, air-tightness, etc. of the outer walls. As these caulking materials filled in these joint grooves which are also called sealing materials, there have been employed silicone-based materials, urethane-based materials, polysulfide-based materials and acrylic materials.

In the above-described process, there sometimes arises so-called three-face adhesion wherein the filled caulking material adheres not only to the side end faces of the outer wallboards but also to the wall substrate. In case where this three-face adhesion arises, the caulking material can hardly stretch horizontally. When the outer wallboards stretch due to a temperature change, therefore, the stress is concentrated toward the part of the caulking material applying to the wall substrate. As a result, the caulking material is cut off and causes water leakage, etc. Therefore, attempts have been made to prevent this three-face adhesion by preliminarily applying pressure-sensitive adhesive tapes for preventing three-face adhesion of caulking materials to the wall substrate to thereby prevent the wall substrate from the adhesion of the caulking material.

As these pressure-sensitive adhesive tapes for preventing three-face adhesion of caulking materials, it has been a practice to use kraft tapes having silicone-based back face releasing agents applied thereon or Japanese paper pressure-sensitive adhesive tapes having Japanese paper for constructional use as the substrate.

However, use of these kraft tapes having silicone-based back face releasing agents applied thereon is accompanied by some troubles as follows. When such a kraft tape having a silicone-based back face releasing agent applied thereon is applied, because a caulking material is made of silicone-based materials in general, the back face of the kraft tape applied to the wall substrate is liable to adhere to the caulking material, thereby causing three-face adhesion in some cases.

On the other hand, use of the Japanese paper pressure-sensitive adhesive tapes for constructional use is accompanied by some troubles as follows. That is, in caulking, the side end faces of outer wallboards are primed to rigidly adhere a caulking material to the side end faces of the outer wallboards. In this step, the excessive primer applied to the side end faces adhere to Japanese paper and thus the Japanese paper is broken, thereby causing three-face adhesion in some cases.

As discussed above, the conventional pressure-sensitive sensitive adhesive tapes for preventing three-face adhesion have both advantages and disadvantages and three-face adhesion cannot be sufficiently prevented with the use of any caulking materials.

### SUMMARY OF THE INVENTION

This invention, which has been made in order to overcome the above-described problems encountering in the prior art, aims at providing pressure-sensitive adhesive tapes for effectively preventing three-face adhesion of caulking materials in caulking.

The pressure-sensitive adhesive tape for preventing three-face adhesion of caulking materials according to the invention is a pressure-sensitive adhesive tape for preventing three-face adhesion of caulking materials which comprises a tape-type substrate having provided on one face of the tape-type substrate a pressure-sensitive adhesive layer, wherein the above-described substrate comprises at least an exposed plastic sheet face and the plastic sheet face has been surface-roughened.

In the present invention, it is preferable that the above-described plastic sheet face comprises a polyolefin-based sheet.

The above-described plastic sheet face can be surface-roughened by embossing, grooving or notching.

In this case, it is preferable that the above-described plastic sheet face having been surface-roughened by embossing has an average center-line roughness Ra of 2 μm or above.

The joiner according to the invention is a joiner for bonding outer wallboards adjacent to each other, wherein the above-described joiner has the pressure-sensitive adhesive tape for preventing three-face adhesion of caulking materials according to the invention at least on the face on which a joint groove is formed.

The first working method for caulking according to the invention is a working method for caulking by filling a caulking material in a joint groove, wherein the above-described working method for caulking comprises applying the pressure-sensitive adhesive tape for preventing three-face adhesion of caulking materials as described above to the exposed face of the substrate of the joint groove and filling the caulking material.

The second working method for caulking according to the invention is a working method for caulking by bonding outer wallboards adjacent to each other with a joiner and filling a caulking material in a joint groove formed by both of the outer wallboards and the joiner, wherein the above-described working method for caulking comprises applying the pressure-sensitive adhesive tape for preventing three-face adhesion of caulking materials as describe above at least to the face of the above-described joiner on which a joint groove is formed and filling the caulking material.

### BRIEF DESCRIPTION OF THE DRAWING

FIG. 1 is a diagram illustrating a working method for caulking according to an embodiment of the invention.

Explanation of Each Numerical Symbol

1 pressure-sensitive adhesive tape for preventing three-face adhesion of caulking materials

2 joiner

3 outer wallboard

4 joint groove

5 caulking material

### DETAILED DESCRIPTION OF THE INVENTION

In the pressure-sensitive adhesive tape for preventing three-face adhesion of caulking materials according to the invention, a pressure-sensitive adhesive layer is laminated on one face of a tape-type substrate and the back face of the pressure-sensitive adhesive tape has been roughened.

It is needed that the substrate to be used in the invention has a plastic sheet face at least in the exposed face thereof, i.e., the back face side of the substrate which is to be brought into contact with a caulking material. It is appropriate to use a substrate whereby the adhesiveness to caulking materials can be lessened. As the substrate, use may be made of those made of plastics which have been commonly used in pressure-sensitive adhesive tapes without particular restriction, so long as the penetration of primers applied on the side end faces of outer wallboards can be inhibited and the pressure-sensitive adhesive tape can be prevented from breakage thereby.

Examples of such plastic sheets include polyolefin-based sheets such as polyethylene sheets and polypropylene sheets, and other various plastic sheets such as polyester sheets and nylon-based sheets. Among all, it is favorable from the viewpoints of the non-adhesiveness to caulking materials and mechanical strength such as elongation to use a polyolefin-based sheet such as a polyethylene sheet or a polypropylene sheet.

In the invention, a caulking material may be adhered to any one of the plastic sheet faces as described above. That is to say, it is possible not only to use each of the above-described sheets as a single layer but also to laminate the plastic sheet on other sheet(s), for example, papers such as kraft paper, other plastic sheets and fabrics to form two, three or more layers.

The thickness of the substrate usually ranges from about 20 to 200 μm, preferably from about 100 to 180 μm, though the invention is not restricted thereto. In case of a laminate, it is adequate to control the thickness of the plastic sheet constituting the exposed face so as to allow sufficient surface-roughening at least in the back side of the substrate, as will be discussed hereinbelow.

In the invention, the exposed plastic sheet face as described above is roughened. Namely, the substrate has a back face which has been roughened. In the invention, therefore, the adhesiveness of the pressure-sensitive adhesive tape to caulking materials is lessened by roughening the back face of the substrate which is brought into contact with caulking materials. The roughening method is not particularly restricted, so long as the adhesiveness can be lessened thereby.

The surface roughening may be carried out by embossing, finely grooving or notching the back face. By embossing, a chicken-wire, damask or spot pattern may be formed on the surface as in general cases. By grooving or notching, for example, a number of grooves or notches may be formed in the lengthwise, crosswise or diagonal direction of the substrate either regularly or irregularly. It is also possible to form grooves or notches both in the lengthwise and crosswise directions of the substrate to give a grid pattern or diagonally to form a network pattern. Among these treatments, embossing is advantageous from the viewpoints of easiness in processing and lessening the adhesiveness. Furthermore, the sectional shape of grooves may be, for example, roughly rectangular, roughly triangular or roughly semispherical shape which is not restricted.

From the viewpoint of lessening the adhesiveness to caulking materials, a larger extent of the roughening is the more desirable. In case where the roughening is performed to larger extent, however, the substrate is easily broken. In such a case, moreover, the laminated pressure-sensitive adhesive layer enters into the back face of the rolled pressure-sensitive adhesive tape for preventing three-face adhesion and thus the surface of the pressure-sensitive adhesive layer becomes uneven after unrolling, thereby making the function of the pressure-sensitive adhesive tape lose. Therefore, the roughening should be carried out to such an extent as not causing these demerits.

In case of embossing, more particularly speaking, the average center-line roughness Ra of the back face of the substrate is controlled to at least 2 μm and preferably up to 50 μm as the upper limit. The average center-line roughness Ra of the back face of the substrate more preferably ranges from 3 to 35 μm, most preferably from 10 to 30 μm. When the average center-line roughness Ra is less than 2 μm, three-face adhesion cannot be sufficiently prevented. When it exceeds 50 μm, on the other hand, there arises a fear or causing the above-described demerits, though three-face adhesion can be prevented. In case of grooving or notching, the depth of the grooves or notches may be controlled to about 2 μm. It is also preferable that the upper limit of the depth thereof does not exceed 50 μm. In the invention, the average center-line roughness Ra means a value determined in accordance with JIS-B0601-1994 by using a surface roughness meter (SURFCOM Model 564A, manufactured by TOKYO SEIMITSU CO., LTD.) at a measuring distance of 4 mm, a cut off of 0.8 mm and a measuring speed of 0.3 m/min.

The pressure-sensitive adhesive layer is laminated on the opposite face of the roughened face of the substrate to thereby provide the pressure-sensitive adhesive layer for preventing three-face adhesion according to the invention. The pressure-sensitive adhesive constituting the pressure-sensitive adhesive layer is not particularly restricted but may be appropriately selected from among various publicly known pressure-sensitive adhesives, for example, acrylic pressure-sensitive adhesives such as copolymers comprising 2-ethylhexcyl acrylate or butyl acrylate as the main monomer, rubber-based pressure-sensitive adhesives comprising natural rubber, styrene-butadiene rubber, polyisobutylene rubber or isoprene rubber, solvent-based pressure-sensitive adhesives and hot melt type pressure-sensitive adhesives. The thickness of this pressure-sensitive adhesive layer is not particularly restricted too. Namely, the thickness of the pressure-sensitive adhesive layer may range from 10 to 100 μm as in general cases. It is preferable that the thickness of the pressure-sensitive adhesive layer ranges from 20 to 60 μm.

Depending on the types of the substrate and the pressure-sensitive adhesive layer, the anchoring force between the substrate and the pressure-sensitive adhesive layer may be elevated by subjecting the face of the substrate on which the pressure-sensitive adhesive layer is formed to various treatments such as corona treatment or oxidization treatment, or by forming an undercoating layer comprising a rubber obtained by graft-polymerizing isocyanate rubber or natural rubber with acrylic acid. It is also possible to subject the back face of the substrate to publicly known back face treatments such as printing or coating with a releasing agent. In case of subjecting to such a back face treatment, it is favorable to control the surface roughness to the above-described level after the completion of the back face treatment.

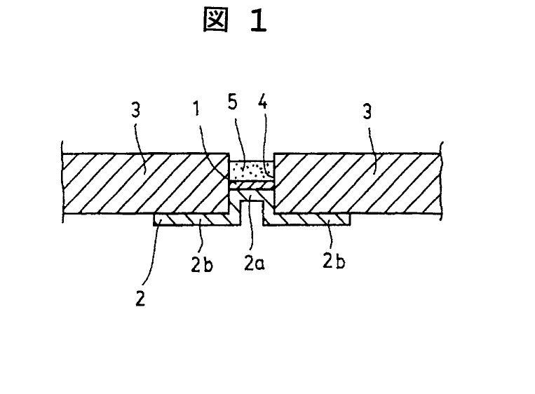

Next, the working method for caulking with the use of the pressure-sensitive adhesive tape for preventing three-face adhesion of caulking materials will be illustrated. FIG. 1 is a diagram showing an embodiment of the working method. In this method, a joiner 2 is used. This joiner 2, which is employed for butting two outer wallboards 3, 3 and bonding the two outer wallboards 3, 3 adjacent to each other, is produced by, for example, pressing a metal plate or molding a plastic material. The joiner is not restricted in shape, so long as it can play the desired role as described above. In general, it has a convex sectional shape provided with a fixing part 2b for the fixation to the back face of the outer wallboard 3 and a convex part 2a located between the side end faces of the two outer wallboards 3, 3, as shown in FIG. 1. A joint groove 4 is formed among the front face of this convex part 2a and the side end faces of the both outer wallboards 3, 3. As FIG. 1 shows, a pressure-sensitive adhesive tape 1 for preventing three-face adhesion of caulking materials is applied to the front face of the convex part 2a forming the joint groove 4 and then a caulking material 5 is filled thereinto. That is to say, the pressure-sensitive adhesive tape 1 for preventing three-face adhesion of caulking materials is applied to the part where the front face of the convex part 2a is exposed as the substrate in the joint groove 4 and thus comes in contact with the caulking material 5. Since the caulking material 5 is filled after applying the pressure-sensitive adhesive tape 1 for preventing three-face adhesion of caulking materials to the face of the joiner 2 on which the joint groove is formed (i.e., the face where the substrate is exposed) coming into contact with the caulking material 5, the three-face adhesion can be prevented and the caulking material 5 can be protected from so-called cracking, etc.

In this step, it is also possible that the two outer wallboards 3, 3 are bonded to each other with the joiner 2 and then the pressure-sensitive adhesive tape 1 for preventing three-face adhesion of caulking materials is applied to the joint groove 4 thus formed. Alternatively, it is possible that the pressure-sensitive adhesive tape 1 for preventing three-face adhesion of caulking materials is applied to the joiner 2 at the working site and then the outer wallboards 3 are bonded to each other. It is also possible that the pressure-sensitive adhesive tape 1 for preventing three-face adhesion of caulking materials is applied to the joiner in the process of producing the same to thereby provide the joiner having the pressure-sensitive adhesive tape 1 preliminarily applied thereto. In this case, no application procedure is needed in the working site and thus the working efficiency can be elevated. Although the pressure-sensitive adhesive tape 1 for preventing three-face adhesion of caulking materials is applied to the part to be contact in the caulking material 5, that is, the front face of the convex part 2a of the joiner 2 in the above-described case, it may be applied somewhat over the side faces of the convex part 2a.

Needless to say, the pressure-sensitive adhesive tape 1 for preventing three-face adhesion of caulking materials is appropriately usable not only in case of applying to the joiner 2 as in FIG. 1 but also in case of using no joiner 2. In the latter case, the pressure-sensitive adhesive tape 1 for preventing three-face adhesion of caulking materials may be applied directly to an exposed substrate face, such as a wall substrate exposed in the joint groove 4. Namely, the pressure-sensitive adhesive tape 1 for preventing three-face adhesion of caulking materials may be preliminarily applied to the substrate serving as the joint groove 4 and then the outer wallboard 3 is bonded thereto. Alternatively, the outer wallboard 3 is fixed and then the pressure-sensitive adhesive tape 1 for preventing three-face adhesion of caulking materials is applied to the exposed substrate face.

The pressure-sensitive adhesive tape for preventing three-face adhesion of caulking materials according to the invention, which comprises a tape-type substrate having provided on one face thereof a pressure-sensitive adhesive layer, has at least an exposed plastic sheet face and this plastic sheet has been surface-roughened by, for example, embossing or grooving. Thus, the adhesiveness of the back face of the pressure-sensitive adhesive tape to caulking materials can be lessened. Owing to this construction, a caulking material coming into contact with the back face of the pressure-sensitive adhesive tape would not rigidly adhere thereto. Since the pressure-sensitive adhesive tape for preventing three-face adhesion of caulking materials has a plastic sheet face exposed on the back face thereof, it is hardly broken by a primer and shows a lessened adhesiveness even in case of using a silicone-based caulking material. Therefore, use of the pressure-sensitive adhesive tape for preventing three-face adhesion of caulking materials according to the invention makes it possible to effectively prevent so-called three-face adhesion.

When the above-described plastic sheet face is made up of a polyolefin-based sheet, the stretchability as a pressure-sensitive adhesive tape and the non-adhesiveness to caulking materials can be particularly improved.

This pressure-sensitive adhesive tape for preventing three-face adhesion of caulking materials is also applicable to the case of using a joiner for bonding two outer wallboards. By applying the pressure-sensitive adhesive tape to the face of the joiner on which a joint groove is formed, three-face adhesion to the joiner can be effectively prevented. In case where the joiner having the pressure-sensitive adhesive tape for preventing three-face adhesion of caulking materials preliminarily applied thereto is presented, no application procedure is needed in the working site and thus the working efficiency can be elevated.

To further illustrate the invention in greater detail, and not by way of limitation, the following Examples will be given.

Various pressure-sensitive adhesive tapes for preventing three-face adhesion of caulking materials were produced and the effects of the invention was confirmed.

### EXAMPLE 1

As a substrate, a polypropylene (PP) sheet of 80 μm 3in thickness was employed and the back face thereof was embossed to form a damask pattern in such a manner as to give an average center-line roughness Ra of 30 μm. Next, a rubber-based pressure-sensitive adhesive comprising 100 parts by weight of natural rubber, 50 parts by weight of a petroleum-based tackifier (Trade name: ESCOREZ 1310, manufactured by Tonex Company Ltd.) and 2 parts by weight of an antioxidant (Trade name: Sumilizer NW, manufactured by Sumitomo Chemical Company, Limited) was applied on the other face of the substrate and dried to give a thickness of 40 μm/dry thus forming a pressure-sensitive adhesive layer. Thus a pressure-sensitive adhesive tape for preventing three-face adhesion of caulking materials was obtained.

### EXAMPLE 2

As a substrate, a laminate tape (Kraft PE Laminate) of 180 μm in thickness consisting of a Clupack Kraft Paper weighing 73 g and a polyethylene sheet of 30 μm in thickness laminated thereon was employed and the back face of the polyethylene sheet layer of the substrate was embossed to form a chicken-wire pattern in such a manner as to give an average center-line roughness Ra of 10 μm. Next, an SIS (styrene-isoprene-styrene) based hot melt pressure-sensitive was applied on the other face of the substrate and dried to give a thickness of 25 μm/dry thus forming a pressure-sensitive adhesive layer. Thus a pressure-sensitive adhesive tape for preventing three-face adhesion of caulking materials was obtained.

### EXAMPLE 3

As a substrate, a polyethylene (PE) sheet of 100 μm in thickness was employed and the back face thereof was embossed to form a damask pattern in such a manner as to give an average center-line roughness Ra of 15 μm. Next, an acrylic pressure-sensitive adhesive comprising an acrylic polymer of a copolymer (weight-average molecular weight: 500,000) of 100 parts by weight of butyl acrylate with 3 parts by weight of acrylic acid, and 2 parts by weight of an isocyanate crosslinking agent (Trade name: Coronate L, manufactured by Nippon Polyurethane Industry, Co., Ltd.) was applied on the other face of the substrate and dried to give a thickness of 30 μm/dry thus forming a pressure-sensitive adhesive layer. Thus a pressure-sensitive adhesive tape for preventing three-face adhesion of caulking materials was obtained.

### EXAMPLE 4

As a substrate, a polyvinyl chloride (PVC) sheet of 200 μm in thickness was employed and the back face thereof was embossed to form a damask pattern in such a manner as to give an average center-line roughness Ra of 50 μm. Next, an acrylic pressure-sensitive adhesive comprising an acrylic polymer of a copolymer (weight-average molecular weight: 620,000) of 95 parts by weight of 2-ethylhexyl acrylate with 5 parts by weight of acrylic acid, and 3 parts by weight of an isocyanate crosslinking agent (Trade name: Coronate L, manufactured by Nippon Polyurethane Industry, Co., Ltd.) was applied on the other face of the substrate and dried to give a thickness of 30 μm/dry thus forming a pressure-sensitive adhesive layer. Thus a pressure-sensitive adhesive tape for preventing three-face adhesion of caulking materials was obtained.

### EXAMPLE 5

As a substrate, a polyolefin-based sheet obtained by extruding a blend of PE with PP (PE:PP=10:90 by weight) of 50 μm in thickness was employed and the back face thereof was embossed in such a manner as to give an average center-line roughness Ra of 2 μm. Next, an acrylic pressure-sensitive adhesive comprising an acrylic polymer of a copolymer (weight-average molecular weight: 430,000) of 97 parts by weight of 2-ethylhexyl acrylate with 3 parts by weight of acrylic acid, and 3 parts by weight of an isocyanate crosslinking agent (Trade name: Coronate L, manufactured by Nippon Polyurethane Industry, Co., Ltd.) was applied on the other face of the substrate and dried to give a thickness of 30 μm/dry thus forming a pressure-sensitive adhesive layer. Thus a pressure-sensitive adhesive tape for preventing three-face adhesion of caulking materials was obtained.

### COMPARATIVE EXAMPLE 1

A pressure-sensitive adhesive tape for preventing three-face adhesion of caulking materials of Comparative Example 1 was obtained as in Example 1 but omitting the embossing of the back face of the substrate to form a damask pattern.

### COMPARATIVE EXAMPLE 2

Use was made of a marketed kraft tape (Trade name: No. 712, manufactured by Nitto Denko Corporation) having a silicone-based back face releasing agent applied thereto.

### COMPARATIVE EXAMPLE 3

Use was made of a marketed Japanese paper pressure-sensitive adhesive tape for constructional use (Trade name: No. 720, manufactured by Nitto Denko Corporation).

The pressure-sensitive adhesive tapes for preventing three-face adhesion of caulking materials of the above-described Examples and Comparative Examples were tested in the pressure-sensitive adhesive strength and the releasing force between the tape back face and a caulking material by the following methods. At the same time, the releasability of the caulking material was sensorily evaluated. Table 1 summarizes the results.

<Pressure-sensitive Adhesive Strength>

Measurement was made in accordance with JIS Z-0237.

<Releasing Force Between Tape Back Face and Caulking Material>

In a 23° C., 65% RH atmosphere, each pressure-sensitive adhesive tape of 10 mm in width was used. A one-component denatured silicone type caulking material was applied on the back face of the substrate of each pressure-sensitive adhesive tape to give a thickness of 200 μm and then allowed to stand at ordinary temperature for 7 days. After 7 days, the caulking material was released at a speed of 0.3 m/min in the direction of 180° and the releasing force was measured with a Tensilon meter (TRM-250, manufactured by ORIENTEC CO., LTD.).

<Releasability of Caulking Material>

By using each pressure-sensitive adhesive tape of 10 mm in width, a one-component denatured silicone type caulking material was applied on the back face of the substrate of each pressure-sensitive adhesive tape to give a thickness of 10 mm and then allowed to stand at ordinary temperature for 7 days. After 7 days, the caulking material was released with hand and the releasability was sensorily evaluated. “A” stands for easily releasable, “B” stands for releasable with a somewhat heavy touch, and “C” stands for not releasable.

TABLE 1

| | | | | | | Compar- | Compar- | Compar- |
|---|---|---|---|---|---|---|---|---|
| | | | | | | ative | ative | ative |
| | Example 1 | Example 2 | Example 3 | Example 4 | Example 5 | Example 1 | Example 2 | Example 3 |
| Substrate | PP | Kraft PE | PE | PVC | PP/PE | PP | Kraft | Japanese |
| | | Laminate | | | | | (No. 712) | paper |
| | | | | | | | | (No. 720) |
| Substrate thickness | 80 | 180 | 100 | 200 | 50 | 80 | | 95 |
| (μm) | | | | | | | | |
| Average surface | 30 | 10 | 15 | 50 | 2 | 1.2 | 7 | 15 |
| roughness (Ra) (μm) | | | | | | | | |
| Pressure-sensitive | Rubber- | SIS-base | Acrylic | Acrylic | Acrylic | Rubber- | SIS-base | Rubber- |
| adhesive | base | | | | | base | | base |
| composition | | | | | | | | |
| Pressure-sensitive | 3.42 | 4.87 | 3.75 | 3.92 | 4.09 | 3.42 | 4.37 | 1.26 |
| adhesive strength | | | | | | | | |
| (N/10 mm) | | | | | | | | |
| Releasing force | 0.18 | 0.2 | 0.3 | 0.7 | 1.6 | 2.5 | ≧5 | ≧5 |
| (N/10 mm) | | | | | | | | |
| Releasability | A | A | A | A | A | B | C | C |
| Remarks | | | | | | Not | | |
| | | | | | | embossed | | |

As Table 1 shows, the pressure-sensitive adhesive tapes of Comparative Examples showed large releasing forces between the tape back face ant the caulking material and the caulking material applied on the back face was hardly releasable. Namely, these tapes showed high adhesiveness between the tape back face and the caulking material. On the other hand, each of the pressure-sensitive adhesive tapes of Examples showed a small releasing force between the tape back face and the caulking material and the caulking material could be easily released. Thus, it was confirmed that these tapes showed low adhesiveness between the tape back face and the caulking material. Moreover, each pressure-sensitive adhesive tape had favorable adhesiveness and sufficiently adhered to the wall substrate. Similar results could be obtained by using caulking materials other than silicone-based caulking materials.

While the invention has been described in detail and with reference to specific embodiments thereof, it will be apparent to one skilled in the art that various changes and modifications can be made therein without departing from the spirit and scope thereof.

What is claimed is:

1. A pressure-sensitive adhesive tape for preventing three-face adhesion of caulking materials which comprises a tape-type substrate having provided on one face of the tape-type substrate a pressure-sensitive adhesive layer, wherein said substrate comprises at least an exposed plastic sheet face and said plastic sheet face has been surface-roughened.

2. The pressure-sensitive adhesive tape for preventing three-face adhesion of caulking materials as claimed in claim 1, wherein said plastic sheet face comprises a polyolefin-based sheet.

3. The pressure-sensitive adhesive tape for preventing three-face adhesion of caulking materials as claimed in claim 1, wherein said plastic sheet face has been surface-roughened by embossing, grooving or notching.

4. The pressure-sensitive adhesive tape for preventing three-face adhesion of caulking materials as claimed in claim 3, wherein an average center-line roughness Ra of the plastic sheet face having been surface-roughened by embossing is 2 μm or above.

5. A joiner for bonding outer wallboards adjacent to each other, wherein said joiner has the pressure-sensitive adhesive tape for preventing three-face adhesion of caulking materials as claimed in claim 1 at least on the face on which a joint groove is formed.

6. A working method for caulking by filling a caulking material in a joint groove, wherein said working method for caulking comprises applying the pressure-sensitive adhesive tape for preventing three-face adhesion of caulking materials as claimed in claim 1 to the exposed face of the substrate of said joint groove and filling the caulking material.

7. A working method for caulking by bonding outer wallboards adjacent to each other with a joiner and filling a caulking material in a joint groove formed by both of the outer wallboards and the joiner, wherein said working method for caulking comprises applying the pressure-sensitive adhesive tape for preventing three-face adhesion of caulking materials as claimed in claim 1 at least to the face of said joiner on which a joint groove is formed and filling the caulking material.
